(19) United States
(12) Patent Application Publication
(10) Pub. No.: US 2019/0041527 A1
(43) Pub. Date: Feb. 7, 2019

(54) GPS-BASED NAVIGATION SYSTEM USING A NONLINEAR DISCRETE-TIME TRACKING FILTER

(71) Applicant: THE CHARLES STARK DRAPER LABORATORY, INC., Cambridge, MA (US)

(72) Inventor: DONALD EUGENE GUSTAFSON, Lexington, MA (US)

(73) Assignee: THE CHARLES STARK DRAPER LABORATORY, INC., Cambridge, MA (US)

(21) Appl. No.: 15/668,068

(22) Filed: Aug. 3, 2017

(51) Int. Cl. G01S 19/21; G01S 19/26; G01S 19/30

(52) U.S. Cl. CPC G01S 19/215; G01S 19/30; G01S 19/26

(57) ABSTRACT

A navigation system that utilizes a discrete-time nonlinear filter to obtain a navigation solution using GPS signals and optional aiding sensor data is described. A nonlinear filter offers improved accuracy over linearized filters at low signal to noise ratios. A discrete-time nonlinear filter guarantees positive-definite calculated covariance matrices under all conditions without requiring any compensation or added parameters. The navigation system receives a modernized global navigation satellite system (GNSS) signal and correlates a digitized copy of the GNSS signal to generate flinging code measurements. A conditional probability density function for the code measurements is determined and used to calculate arbitrary moments of code delay and other expected values. The code measurements and the conditional probability density function are processed in a nonlinear tracking filter to generate recursive navigation state updates, which can be used by an output device, such as a display, to present navigation and tracking information.

### FIELD OF INVENTION

The present disclosure relates generally to a satellite navigation system having improved performance in high jamming and low signal strength environments.

### BACKGROUND

In a typical Global Positioning System (GPS) based navigation system, a navigation receiver is arranged to receive navigation signals transmitted by satellites orbiting Earth. The satellites are typically synchronized with one another and arranged so that the navigation signals include information such as the satellite's location and current clock time. Since the satellites are positioned in different locations, knowledge of the propagation time of a signal from each satellite to the receiver can be analyzed to estimate the position and motion of the receiver in three dimensions.

The navigation signal from each satellite is modulated by a pseudorandom code (a “ranging code”) that is known to the receiver, and which the navigation system uses in measuring the time of arrival of the signals. By measuring the misalignment in time of the received ranging code and a locally-generated copy of that ranging code (the “code delay”), for each satellite, the navigation system can estimate the propagation time of the navigation signal from each satellite to the receiver. The propagation times may be expressed as distances, which are known as “pseudoranges” because they depend not only on the actual range from the receiver to each satellite, but also on the alignment of the navigation system time bases and other effects. The navigation system can analyze the pseudoranges to the different satellites to estimate the position and motion of the receiver. Further, the navigation system can supplement the information obtained from the navigation signal by using data obtained by aiding sensors. For example, inertial sensors, such as accelerometers or gyroscopes, can be used as aiding sensors to improve the performance of the navigation system.

In addition to position/location information, the navigation system can use data from space-based (e.g., satellite) or ground-based (e.g., inertial sensors) terminals to obtain other information (e.g., velocity) regarding a mobile platform on which the navigation system may be positioned. Also, as noted in U.S. Pat. No. 6,331,835, the entire teaching of which is incorporated by reference as if set forth at length herein, satellite navigation data can be used to calibrate other sensors (e.g., inertial sensors), thereby reducing the possibility of navigation system errors when the satellite data is temporarily unavailable or degraded by intentional or unintentional interference.

In most modern GPS-based navigation system, interference can have adverse effects on GPS code and carrier tracking. Although various techniques for reducing interference have been developed, many of these techniques are ad hoc in that they require case-by-case optimization as receiver and signal characteristics change.

U.S. Pat. No. 6,630,904, U.S. Pat. No. 6,331,835, and U.S. Pat. No. 6,731,237, the entire teachings of which are incorporated by reference as if set forth at length herein, describe fully integrated designs for achieving near optimal measurements using a GPS-based navigation system. These designs generally apply continuous-time nonlinear filters to obtain a navigation solution using legacy GPS signals or GPS M-Code signals and aiding sensor data. These designs generally employ continuous-time nonlinear filters bear determining conditional moments used to calculate a navigation solution. The nonlinear filters are implemented by using a discrete-time approximation of the exact non-linear filtering equations and, as such, include time quantization effects that can lead to non-positive definiteness of an estimated covariance matrix used in calculating the navigation solution.

Embodiments described herein relate to apparatus, methods, computerized systems, and computer program products bier obtaining reliable and accurate satellite-based navigation solutions that include information such as optimal estimates of position, time, velocity, acceleration, attitude and other information regarding the navigation system or a mobile platform to which the navigation system may be affixed. The mobile platform may be an aircraft, spacecraft, missile, ship, submarine, land vehicle, or any other structure capable of movement, including the navigation system by itself. Embodiments described herein can be used with navigation receivers that utilize various global navigation satellite systems (GNSS) signals, for example, Galileo, GLONASS, or BeiDou, in addition to GPS.

Embodiments of the present invention utilize a deep integration (DI) mechanism in conjunction with an M-code GPS signal and include a unique, nonlinear tracking filter, which provides significant performance advantages over conventional GNSS navigation systems when operating with or without aiding sensors. Embodiments of the invention overcome the error covariance matrix non-positive definiteness problem that occurs in conventional approaches requiring time-discretization of continuous-time nonlinear filtering equations. Moreover, in embodiments of the invention that separately make code measurements on the basis of the sidebands of the M-Code GPS signal in addition to the full band signal, the addition of the sideband measurements reduces estimation errors and results in significantly improved code tracking performance in severe jamming environments.

In general, in one aspect, embodiments of the invention utilize a DI mechanism with an M-code GPS signal and measurements from inertial navigation systems (INS) or other aiding sensors, which provide additional performance advantages in demanding applications, including advantages over conventional ultra-tightly coupled (UTC) navigation techniques. The present invention addresses possible challenges to receiver signal processing that may arise due to multiple correlation peaks of M-code signals. Specifically, recognizing that legacy Deep integration techniques disclosed in U.S. Pat. No. 6,630,904, U.S. Pat. No. 6,331,835, and U.S. Pat. No. 6,731,237 can be unable to obtain a navigation solution (because of non-positive definite error covariance matrices which arise when measurements are highly accurate), the problem of non-positive definiteness associated with the discrete-time approximation of a continuous-time Gaussian moment filter is mitigated using a discrete-time formulation of the code-tracking algorithm.

In general, in another aspect, embodiments of the invention, feature a navigation system for a mobile platform, including a navigation receiver, a correlator bank, a detector, a predictor, and a discrete-time nonlinear tracking filter. The navigation receiver receives an analog signal containing global navigation satellite system data, and generates from it a received navigation signal in the form of digitized samples. The correlator bank generates a discrete correlation function on the basis of the received navigation signal and a reference navigation signal stored in the navigation system. The detector generates discrete-time ranging code measurements on the basis of the discrete correlation function. The predictor estimates a conditional probability density function (conditional PDF) of ranging code delay as a function of the discrete-time ranging code measurements. The conditional PDF quantifies the probability that, a hypothesized ranging code delay is realized, given the discrete-time ranging code measurements. The discrete-time nonlinear tracking filter estimates navigation state elements of file mobile platform as a function of the conditional PDF.

In various embodiments, the navigation system may include one or more supplementary sensors that measure attributes of position, attitude, or motion of the mobile platform, and the nonlinear tracking filter processes the conditional PDF together with the measurements obtained by the supplementary sensors, to generate estimates of the navigation state elements of the mobile platform. The supplementary sensors may include at least one inertial sensor, for example, an accelerometer or a gyroscope, or both. The supplementary sensors may measure the position, velocity, acceleration, attitude, rotation rate, change in position, change in velocity, and change in attitude of the mobile platform. Other examples of supplementary sensors include imagers, gravimeters, barometers, altimeters, and magnetometers, which may provide signals that are functions of one or more navigation measurements, according to a sensor model. While the navigation system does not require supplementary sensors to obtain a navigation solution that per better than conventional approaches in high jamming environments, use of the supplementary sensors may provide other performance improvements.

In various embodiments, the detector may multiply the discrete correlation function by a discrete weighting function and generate the discrete-time ranging code measurements from the product. The nonlinear tracking filter generates the discrete weighting function as a function of a pseudo-range error and a noise and interference to signal ratio.

In various embodiments, the navigation system may include an upper sideband selection filter or a lower sideband selection filter, or both. The sideband selection filters apply to the received navigation signal an upper or lower bandpass filter, each having a passband above or below the carrier frequency of the navigation signal, respectively. The sideband selection filters thereby produce a bandpass-limited upper sideband signal or a bandpass-limited lower sideband signal, respectively. The correlator bank may comprise two or more groups of correlators, each group of correlators processing one of the received navigation signal, the upper sideband and the lower sideband signal. Each group of correlators produces a discrete correlation function on the basis of the received navigation signal or sideband signal and a corresponding reference navigation signal stored in the navigation system. The detector may generate the discrete-time ranging code measurements on the basis of all of the discrete correlation functions, produced by every group of correlators, taken together.

In general, in yet another aspect, embodiments of a navigation system feature a navigation receiver, an upper sideband selection filter or a lower sideband selection filter, or both, a correlator bank, a detector, a predictor, and a discrete-time nonlinear tracking filter. The navigation receiver receives an analog signal containing global navigation satellite system data and generates from it a received navigation signal in the firm of digitized samples. The upper sideband selection filter and the lower sideband selection filter each generate from the received. navigation signal a bandpass-limited upper sideband signal or a bandpass-limited lower sideband signal, respectively. The correlator bank includes two or more groups of correlators. Each group of correlators generates a discrete correlation function on the basis of one of two or more reference navigation signals stored in the navigation system and one of the received navigation signal, the upper sideband signal, and the lower sideband signal. The detector generates discrete-time ranging code measurements on the basis of all of the discrete correlation functions, produced by every group of correlators, taken together. The predictor estimates a conditional probability density function (conditional PDF) of ranging code delay as a function of the discrete-time ranging code measurements. The conditional POE quantifies the probability that a hypothesized delay is realized, given the discrete-time ranging code measurements. The discrete-time nonlinear tracking filter generates estimates of navigation state elements of the mobile platform as a function of the conditional PDF.

In general, in still another aspect, embodiments of the invention feature a method for generating estimates of navigation state elements of a mobile platform. The method includes receiving an analog signal containing global navigation satellite system data, and generating from it a received navigation signal in the form of digitized samples. The received navigation signal is correlated with a reference navigation signal stored in the navigation system to form a discrete correlation function. Discrete-time ranging code measurements are detected from the discrete correlation function. A conditional probability density function (conditional PDF) of ranging code delay is estimated as a function of the discrete-time ranging code measurements. The conditional PDF quantifies the probability that a hypothesized delay is realized, given the discrete-time ranging code measurements. The navigation state elements of the mobile platform are estimated using a discrete-time nonlinear tracking filter operating on the conditional PDF.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description, together with the accompanying drawings. The drawings are not necessarily to scale, emphasis instead generally being placed upon illustrating the principles of the invention.

FIG. 1 is a high-level block diagram of an exemplary navigation system according to embodiments described herein.

FIG. 2 is a high-level block diagram of exemplary components that maybe included in the navigation processor shown in FIG. 1.

FIG. 3 is an example of components that may be included in the navigation processor shown in FIG. 1.

FIG. 4 is an example of a full-band M-code GPS power spectral density that can be used with embodiments described herein. The frequency axis indicates an amount of frequency offset from the carrier frequency of the GPS signal.

FIG. 5A illustrates the autocorrelation functions of example M-code signals at various intermediate frequency bandwidths.

FIG. 5B illustrates the squared autocorrelation functions of example M-code signals at various intermediate frequency bandwidths.

FIG. 6A illustrates the upper sideband autocorrelation functions for M-code GPS signals of various intermediate frequency bandwidths, which can be used with the embodiments described herein. The autocorrelation function of the lower sideband M-Code signal (not shown) can be identical to that of the upper sideband.

FIG. 6B illustrates the upper sideband squared autocorrelation functions for M-code GPS signals of various intermediate frequency bandwidths, which can be used with the embodiments described herein. The squared autocorrelation function of the lower sideband M-Code signal (not shown) can be identical to that of the upper sideband.

FIG. 7A illustrates the zeroth order moment of the code measurement as a function of correlator delay, for an a priori value of the root-mean-squared pseudorange estimation error equal to 0.2 M-Code chips, for M-code GPS signals of various intermediate frequency bandwidths.

FIG. 7B illustrates zeroth order moment of the code measurement as a function of correlator delay, for an a priori value of the root-mean-squared pseudorange estimation error equal to 1.0 M-Code chip, for M-code GPS signals of various intermediate frequency bandwidths.

FIG. 8 is an example of procedures that can be conducted in the navigation processor of FIG. 2 in order to determine the conditional probability density function for the ranging code delay measurement.

FIG. 8A illustrates the logarithm of the conditional probability density function for an M-code signal having a jamming to signal (J/S) level of 55 dB, comparing the probability density for a deeply integrated navigation processor that uses only the full band M-Code intermediate frequency (IF) signal to one that uses the full band IF signal and, separately, the M-Code IF sideband signals.

FIG. 9B illustrates the logarithm of the conditional probability density function for an M-code signal having a jamming to signal (J/S) level of 65 dB, comparing the probability density for a deeply integrated navigation processor that uses only the full band M-Code IF signal to one that uses the full band IF signal and, separately, the M-Code IF sideband signals.

FIG. 10A illustrates the conditional cumulative distribution function for estimation errors in delay mode for a deeply integrated navigation processor that uses only the full and M-Code intermediate frequency signal, for a received signal having a jammer to signal (J/S) ratio of 55 dB.

FIG. 10B illustrates the conditional cumulative distribution function for estimation errors in delay mode tor a deeply integrated navigation processor that uses the full band M-Code intermediate frequency (IF) signal and, separately, the M-Code IF sideband signals, for the same J/S ratio as FIG. 10A.

FIG. 11A illustrates the conditional cumulative distribution function for estimation errors in delay mode for a deeply integrated navigation processor that uses only the full band M-Code intermediate frequency signal, for a received signal having a J/S ratio of 65 dB.

FIG. 11B illustrates the conditional cumulative distribution function for estimation errors in delay mode for a deeply integrated navigation processor that uses the full band M-Code intermediate frequency (IF) signal and, separately, the M-Code IF sideband signals, for the same J/S ratio as FIG. 11A.

FIG. 12A illustrates the delay tracking error as a function of J/S ratio for a deeply integrated navigation processor that uses the full band M-Code intermediate frequency (IF) signal and, separately, the M-Code IF sideband signals, in comparison to one that uses only the full band IF signal, for an M-code signal having an a priori root-mean-square (RMS) pseudorange error of 0.2 chip.

FIG. 12B illustrates the delay tracking error as a function of J/S ratio for a deeply integrated navigation processor that uses the full band M-Code IF signal and, separately, the M-Code IF sideband signals, in comparison to one that uses only the full band IF signal, for an M-code signal having an a priori root-mean-square (RMS) pseudorange error of 1.0 chip.

FIG. 13A illustrates the delay tracking error as a function of correlator bank length and spacing, for a deeply integrated navigation processor that uses the full band M-Code intermediate frequency (IF) signal and, separately, the M-Code IF sideband signals, at a J/S ratio of 55 dB, for an M-code signal having an a priori root-mean-square (RMS) pseudorange error of 0.2 chips.

FIG. 13B illustrates the delay tracking error as a function of correlator bank length and spacing, for a deeply integrated navigation processor that uses the full band M-Code IF signal and, separately, the M-Code IF sideband signals, at a ratio of 65 dB, for an M-code signal having an a priori root-mean-square (RMS) pseudorange error of 1.0 chip.

### DETAILED DESCRIPTION

In the Summary above, the Detailed Description and the claims below, and in the accompanying drawings, reference is made to particular features and method steps of the invention. It is to be understood that the disclosure of the invention in this specification includes all possible combinations of those features.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus the term “or” should generally be understood to mean “and/or,” and so forth.

The term “comprises” and grammatical equivalents thereof are used herein to mean that other components or steps are optionally present. For example, and article “comprising components A, B, and C can consist of (i.e., contain only) components A, B, and C, or can contain not only components A, B, and C but also one or more other components.

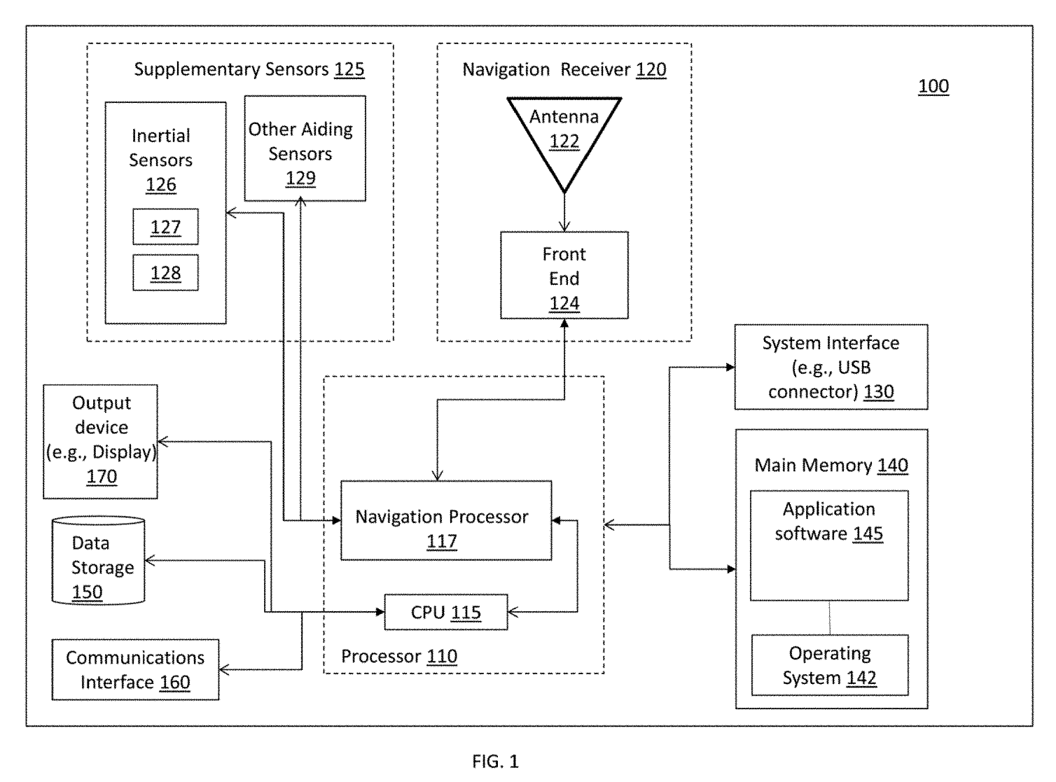

FIG. 1 is a high-level block diagram of a navigation system according to embodiments described herein. The navigation system 100 can include various digital electronic circuits or computer hardware that can be used with the embodiments disclosed herein, for example the digital circuitry associated with or included in a tablet, a mobile communications device, a desktop, or a laptop computer.

As shown in FIG. 1, the navigation system 100 can include a navigation receiver 120 and one or more optional supplementary sensors 125. The navigation receiver 120 can be, a GPS receiver or any other type of global navigation satellite system (GNSS, not shown) receiver utilizing modernized global navigation satellite systems signals known in the art (e.g., GPS, Galileo, GLONASS, BeiDou, etc.).

The navigation receiver 120 can include an antenna 122 for receiving radio signals and a front end 124. The antenna 122 can be any type of antenna known in the art that can receive navigation signals and/or positioning signals from global navigation satellite systems. For example, the antenna 122 can receive radio frequency (RF) signals, r(t), including GPS signals transmitted by multiple satellites. The received signals can be corrupted by noise and/or interference. Depending on the application and the design of the navigation satellite system, the received GNSS signal can be centered at an arbitrary frequency, known as a carrier frequency. For example, GPS navigation signals are transmitted at two carrier frequencies, 1575.42 MHz (Lᵢ) and 1227.60 MHz (L₂) in other possible applications, the received GNSS signal can be centered at other frequencies. At any given time, t, the model for a signal received from a single satellite can be generally represented as:

r(t)=\sqrt{2S(t−τ)}C(t−τ)D(t−τ) cos(ω_{c}t+ϕ(t))+J(t),

where S(t) denotes the received signal power, τ denotes time delay (due to atmospheric propagation effects or line-of-sight range), C(t) is a pseudorandom code, D(t) denotes GPS data bit, signals typically transmitted at a 50 Hz rate, ω_{c} denotes the carrier frequency, ϕ(t) represents the phase angle, which can reflect possible Doppler shifts, and J(t) represents thermal background noise and interference.

The antenna 122 can be coupled to a front-end 124. The front-end 124 can be an intermediate frequency (IF) and/or an RF front-end. Generally, the front-end 124 can be any type of RF/IF front-end known in the art that can receive and convert analog navigation signals into corresponding digital signals for further processing by other components of the navigation system 100. The front-end 124 can include one or more receivers for receiving navigational data from global navigation satellites systems. The front-end 124 may comprise, singly or in any combination, any analog or digital circuits or other devices or methods for signal processing that are useful for amplifying, detecting, demodulating, frequency mixing, filtering, synthesizing, sampling, or otherwise processing telecommunications signals.

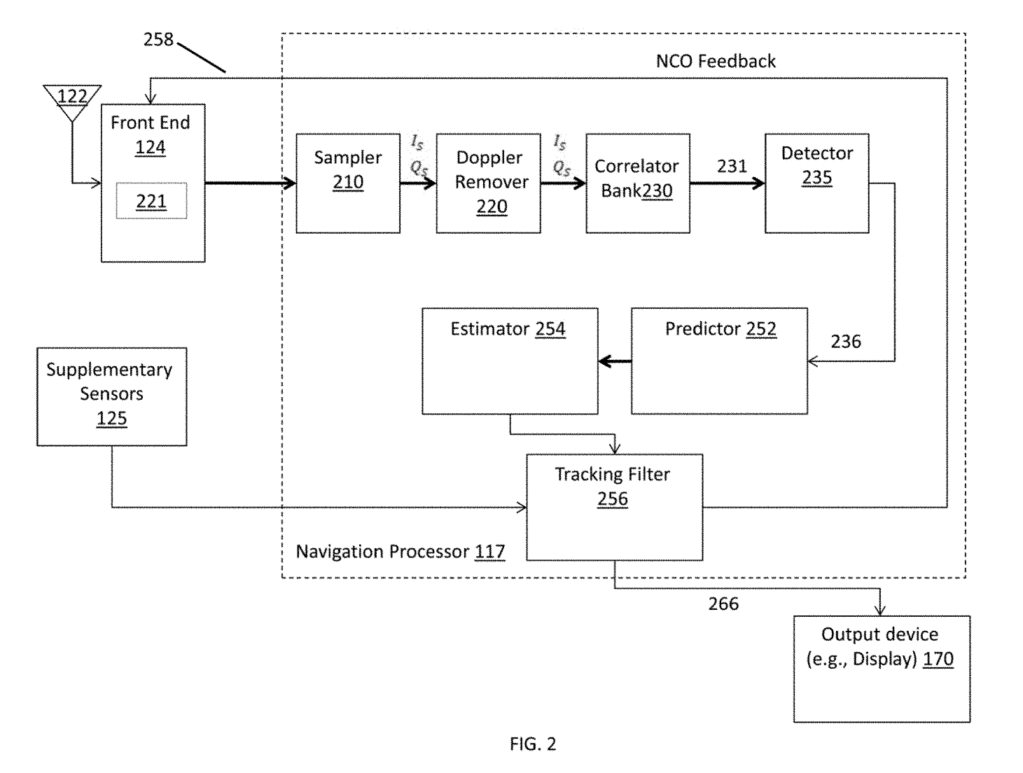

In embodiments, the front end 124 processes the received signal r(t) to generate an intermediate frequency (IF) signal for input to the navigation processor 117. Front-end processing can include removal of power outside of the frequency band of interest and may thereby reduce the amount of unwanted noise or jammer power included in the IF signal. For example, the front-end 124 can include a band-pass filter 221 (shown in FIG. 2) that removes power outside of the frequency band of interest. The front-end 124 can also demodulate the received signal, r(t), to a lower frequency and possibly to rates that are more amenable to processing.

While the navigation system 100 can determine an improved navigation solution on the basis of only the received GNSS signals, it can provide an even more accurate and reliable solution by integrating the measurements of one or more supplementary sensors 125. The supplementary sensors 125 can include any type of sensor known in the art, for example inertial sensors 126 (e.g., accelerometers 127 and gyros 128) or other aiding sensors 129 (e.g., imagers, gravimeters, barometers, altimeters, or magnetometers) For example, the navigation system 100 can include one or more accelerometers 127 and gyros 128 that are configured to sense or measure movement, rotation rate, acceleration, deceleration, or other motions of the navigation system or a platform upon which the navigation system may be mounted (hereinafter collectively referenced as “platform”).

The data obtained by the supplementary sensors 125 can be used to supplement the data received by the navigation receiver to ensure that full navigational solutions (position, velocity, attitude, and time) continue to be maintained in spite of satellite signal degradation over extended periods of time.

The navigation receiver 120 and/or the supplementary sensors 125 can be coupled to a processor 110 and arranged to forward information (e.g., measurements made by the supplementary sensors 125 and/or signals received by antenna 122 and processed by the front end electronics 124) to the processor 110. The processor 110 can be connected to a main memory 140 and include a central processing unit (CPU) 115 that includes processing circuitry configured to manipulate data structures from the main memory 140 and execute various instructions. The processor 110 can include a navigation processor 117. Although shown as independent parts of the processor 110 (and shown as being independent of the CPU 115), the navigation processor 117 can be an integral part of the CPU 115 or the processor 110. As will be discussed later with reference to FIG. 2, the navigation processor 117 is generally responsible for receiving and processing signals forwarded by the front end 124 and/or the supplementary sensors 125.

The processor 110 can be a general and/or special purpose microprocessor and any one or more processors of any kind of digital computer. Generally, the processor 110 can receive instructions and data from the main memory 140 (e.g., a read-only memory or a random access memory or both) and execute the instructions. The instructions and other data can be stored in the main memory 140.

The processor 110 can be connected a communications interface 160. The communications interface 160 can provide the navigation system 100 with a connection to a communications network (not shown). Transmission and reception of data, information, and instructions can occur over the communications network. The processor 110 can also be connected to various interfaces via a system interface 130, which can be an input/output (I/O) device interface (e.g., USB connector, audio interface, FireWire, interface for connecting peripheral devices, etc.). The processor 110 can further be coupled to one or more data storage elements 150 and be arranged to transfer data to and/or receive data from the data storage elements 150.

As noted, the navigation system 100 can include a main memory unit 140. The main memory unit 140 can include an operating system 142. The main memory 140 and the operating system 142 can be configured to implement various operating system functions. For example, the operating system 142 can be responsible for controlling access to various devices, implementing various functions of the navigation system 100, and/or memory management. The main memory 140 can also hold application software 145.

The main memory 140 can be connected to the processor 110 and, possibly, a cache unit (not shown) configured to store copies of the data from the most frequently used main memory 140. The processor 110 and the main memory 140 can be included in or supplemented by special purpose logic circuitry.

The main memory 140 and application software 145 can include various computer executable instructions, application software, and data structures such as computer executable instructions and data structures that implement various aspects of the embodiments described herein.

The techniques described herein, without limitation, can be implemented in digital electronic circuitry or in computer hardware that executes software, firmware, or combinations thereof. The implementation can be as a computer program product, for example a computer program tangibly embodied in a non-transitory machine-readable storage device, for execution by, or to control the operation of, data processing apparatus, for example a computer, a programmable processor, or multiple computers.

The main memory 140 can be any form of non-volatile memory included in machine-readable storage devices suitable for embodying data and computer program instructions. For example, the main memory 140 can be magnetic disk (e.g., internal or removable disks), magneto-optical disks, one or more of a semiconductor memory device (e.g., EPROM or EEPROM), flash memory, CD-ROM, and/or DVD-ROM disks.

The program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be executed on a computer, or on multiple computers, at one site or distributed across multiple sites and interconnected by a communications network.

One or more programmable processors can execute a computer program to operate on input data, perform the functions and methods described herein, and/or generate output data. An apparatus can be implemented as, and method steps can also be performed by, special purpose logic circuitry, such as a field programmable gate array (FPGA) or an application specific integrated circuit (ASIC). Modules can refer to portions of the computer program and/or the processor or special circuitry that implements that functionality.

The navigation system 100 can also include an output device (e.g., display) 170 for receiving, outputting, and/or displaying information (e.g., monitor, display screen, etc.). The display 170 can be a touch-sensitive display and/or any type of display known in the art.

FIG. 2 is a high-level block diagram of components that may be included in the navigation processor 117 shown in FIG. 1. As noted above, the navigation processor 117 can be an integral or independent part of the processor 110. The navigation processor 117 can be associated with a vehicle or mounted in a vehicle.

The navigation processor 117 receives signals and information forwarded by the antenna 122, front-end 124, and/or supplementary sensors 125. As noted the optional supplementary sensors 125 can include one or more gyros, accelerometers, or other aiding sensors that sense or measure the movements, position, or attitude of a platform (not shown) to, which the navigation processor 117 may be attached. For example, the supplementary sensors 125 can include at least three gyros and at least three accelerometers that sense rotation rate, acceleration, deceleration, or other motions of the platform in three dimensions (i.e., about three orthogonal axes that can be defined for the platform). Although not shown, the supplementary sensors 125 can be coupled with an error corrector that can estimate possible errors in the measurements obtained by the gyros and/or accelerometers and correct such errors (e.g., bias, misalignment, scale factor error, etc.).

The antenna 122 can be an antenna included in a GPS receiver or other type of global navigation satellite system receiver. The antenna 122 can receive a signal, including positioning or navigation data, from remote global navigation satellites (not shown). As noted, the antenna 122 can be coupled to a radio frequency/intermediate frequency (RF/IF) front end 124. The front end 124 can include one or more receivers for receiving the navigation data.

The front end 124 and/or the navigation processor 117 can process the signal forwarded by the antenna to generate in-phase, I(t), and quadrature, Q(t), components of the received signal. In a standard system, these components can be 90° out of phase.

The sampler 210 can sample and digitize the in-phase, I(t), and quadrature, Q(t), components of the received signal. The resulting digitized and sampled signals, I_{S} and Q_{S}, can be generated at any desirable rate, for example at a sampling rate of 10 Mega Hertz (MHz). Although shown as a part of the navigation processor 117, the sampler 210 can be included in the front end 124.

A Doppler remover 220 can remove possible effects of Doppler shifts (estimated Doppler shifts) from the sampled signals. The Doppler remover 220 can utilize a reference signal from a numerically controlled oscillator (NCO) that is controlled by NCO feedback 258 that is a function of code loop measurements. The resulting in-phase, I_{S}, and quadrature, Q_{S}, signal components can contain phase error.

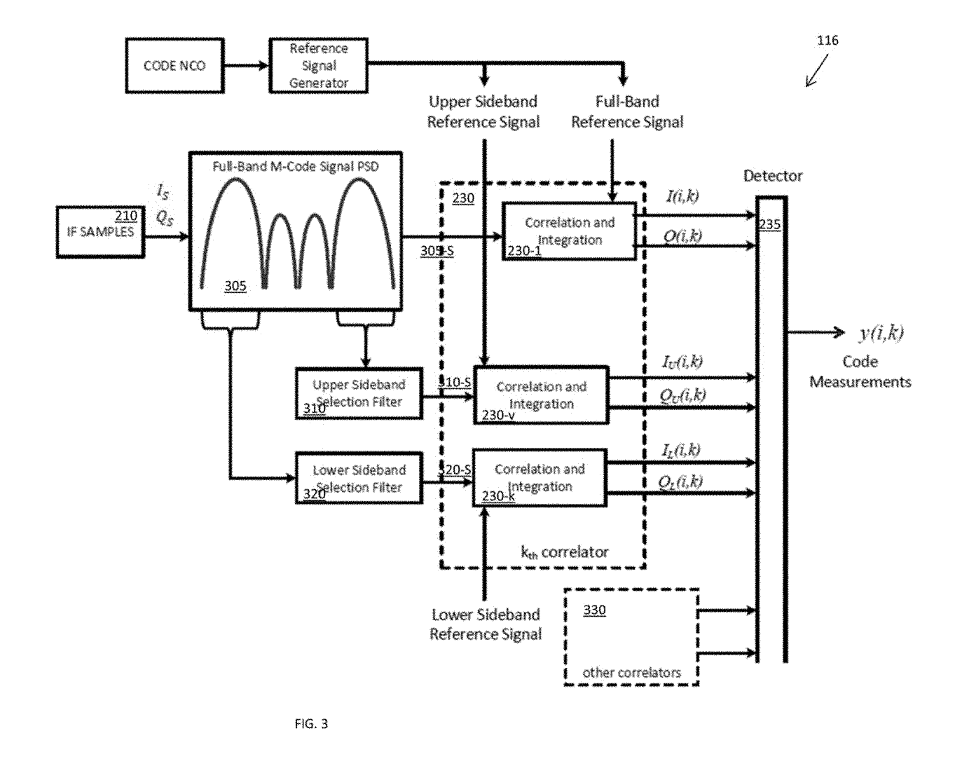

The discrete in-phase, I_{S}, and quadrature, Q_{S}, signal components can also be optionally processed by a sideband processor (shown later in FIG. 3). As will be described later with reference to FIG. 3, the sideband processor can include an upper sideband processor (shown in FIG. 3) and a lower sideband processor (shown in FIG. 3) that can process the upper and lower sidebands of the in-phase and quadrature components separately.

The discrete in-phase, I_{S}, and quadrature, Q_{S}, signal components are for to a correlator bank 230 that operates to separate the GPS signal from noise and interference that may be included in the signal. While FIG. 2 illustrates a single correlator bank 230, the navigation processor 117 may include any number of correlator banks 230, each correlator bank 230 computing a discrete correlation function of the full-band IF signal or, optionally, a band-limited version of the IF signal, with a locally-generated copy of a ranging code waveform transmitted by a particular GPS satellite. Each correlator bank 230 may include one or more correlators (as shown in FIG. 3). For example, the correlator bank 230 can include a large number of correlators, for example 100 correlators. In effect, each correlator compares a sampled IF signal with a local copy of a ranging code waveform at a particular value of time delay. The correlators may be spaced uniformly in delay, and the spacing may be variable to adapt to changes in signal, noise, and jammer power. The correlators can compute the correlations over a predetermined interval. For example, the correlations can be computed over a 20 millisecond interval, synchronized with a 50 Hz data bit interval. The correlator bank 230 can include one or more in-phase, I_{S}, and quadrature, Q_{S}, correlators.

Each correlator typically includes an integrator (not shown) that performs an integrate-and-dump function over the predetermined correlator interval, as part of the discrete correlation computation.

The output of a correlator, k, where correlators range from −m, . . . , m, at time point i can be represented as:

I(i,k)=δt\sqrt{2S(i)}D(i)R_{c}(e_{τ(i)}+kΔ) cos e_{θ}(i)+ [symbol] (i,k)

Q(i,k)=δt\sqrt{2S(i)}D(i)R_{c}(e_{τ(i)}+kΔ) sin e_{θ}(i)+ [symbol] (i,k)

where I(i,k) and Q(i,k) denote discrete time in-phase and quadrature correlator output signals, respectively, δt denotes the predetermined interval over which correlation is carried, Δ represents the spacing between the correlators in the correlator bank (e.g., in unit of chips), e_{θ} denotes the carrier phase error, e_{τ(i)} refers to the delay error, and R_{c} denotes the correlation function. The terms [symbol] and [symbol] represent the effects of thermal noise and possible interference. The correlation function can be represented as:

$${R}_{c ( x )} = \frac{1}{p} {\sum }_{i = 1}^{p} C ( iT ) {C}_{replica} ( iT - x )$$

where p denotes the number of samples, C(iT) denotes a pseudo-random code after sampling, C(iT−x) denotes a pseudo-random code after sampling delayed by x, generated within the receiver, and

$$\frac{1}{T}$$

is the chipping rate.

Conventional navigation systems typically employ three correlators per channel at different values of delay (e.g., early, prompt, and late) with a predetermined spacing (e.g., one-half chip). An error signal can be generated by differencing the outputs of select correlators (e.g., early and late), represented as a variable, α(eₗₒₛ). The error variable can be a function of the navigation position error along the line of sight between the receiver and the current satellite, eₗₒₛ. An extended range correlator, having a large number of correlators spread over a range of delay values beyond early and late, can also be employed. The number of correlators employed in the extended range correlator bank can theoretically be limitless. When using an extended range correlator bank, the outputs from each correlator may be processed by a detector that applies an optimal weighting function to the correlator outputs, multiplying each correlator output by a separate weighting value so as to account directly for the present signal and noise power estimates, and any measurement nonlinearities, which increase with the level of noise and interference in the received signal. Nonlinear estimation techniques can be used to calculate the optimal weighting functions.

The correlator output 331 can be forwarded to a detector 235, for example a square law detector 235, that can obviate the need for a carrier lock by eliminating both a carrier phase error, e_{θ}, and the data bit, D(i). The detector 235 can provide a sum of the squares of the correlator output functions, I(i,k) and Q(i,k) according to the relationship

$$y ( j , k ) = {\sum }_{i}^{ } [ {l}^{2} ( i , k ) + {Q}^{2} ( i , k ) ]$$

where y(j,k) represents the code measurement 236 from the k-th correlator at the j-th sample time.

Deep Integration generally can compute optimal correlator weights on the fly, as a function of jammer-to-signal ratio or, generally, noise and interference-to-signal ratio, and pseudorange root-mean-square (RMS) error. The pseudorange error is the position error along a line-of-sight between a GPS satellite and a GPS receiver, and corresponds to a delay error in a received GPS signal. A navigation solution utilizing Deep Integration can, therefore, continuously adapt to changes in the jamming environment. For example, in the presence of intense jamming, the GPS measurements can be so noisy that the navigation filter applies near-zero weights to them. In that event, the navigation error is determined by the velocity errors and the characteristics of any aiding navigation sensors (e.g., inertial measurement units, magnetometers, star cameras or barometric or radar altimeters) that are integrated in the solution.

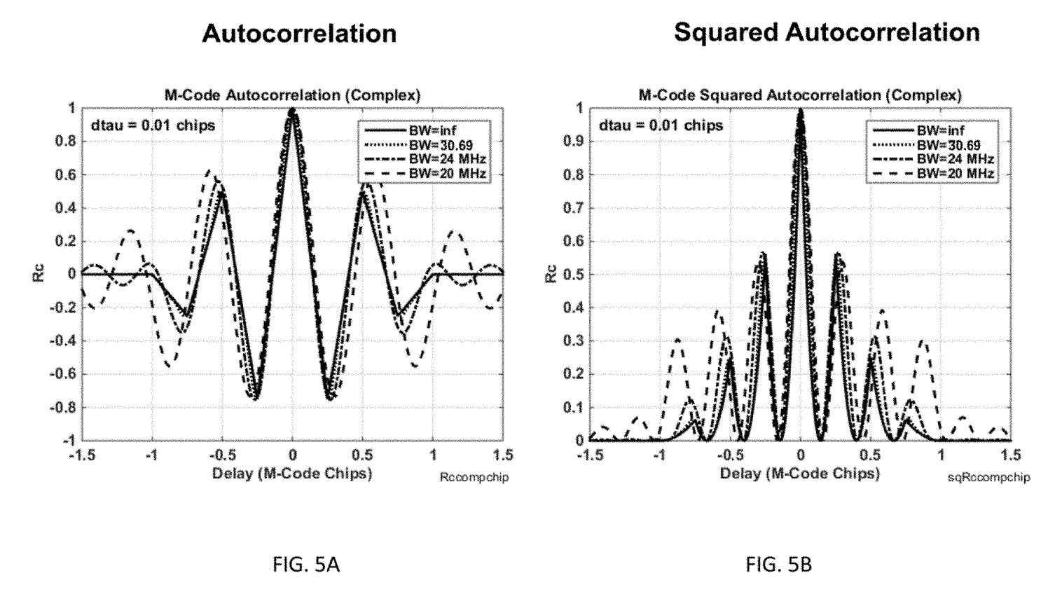

Deep Integration can directly account for the effects of measurement nonlinearities, which are significant at high jamming-to-signal (J/S) levels. Because an M-Code autocorrelation function is multi-peaked as a function of code delay (as shown later in FIG. 5A), M-Code tracking is highly sensitive to correlator spacing. Deep Integration can automatically apply optimal weights to all correlator outputs to construct the optimal detector shape, in contrast to Deep Integration, conventional linear filtering techniques rely on fixed linear combinations of the correlator outputs and cannot accommodate arbitrary correlator structures. As a result, the linear techniques must be supplemented by ad hoc approaches in order to address the nonlinear M-Code correlation function.

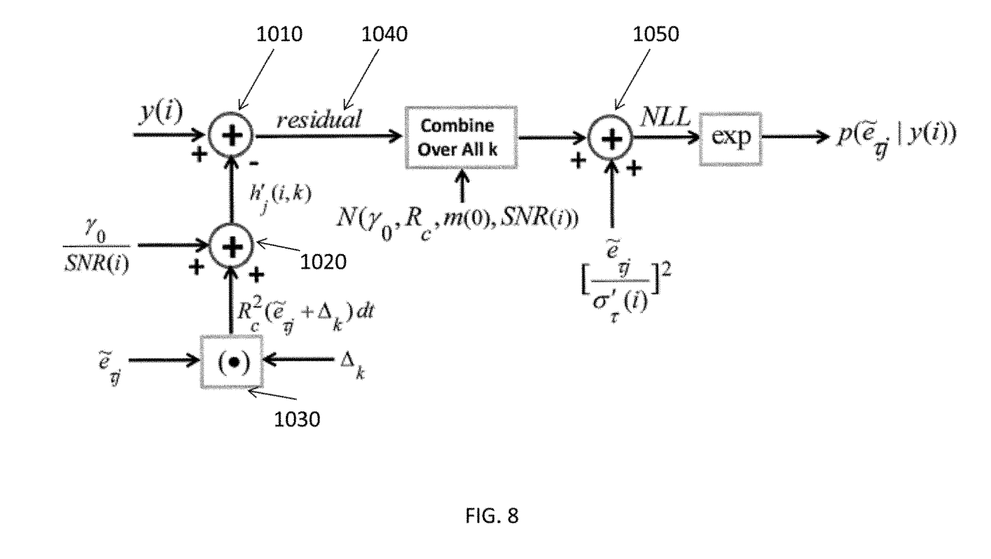

However, the discrete-time approximation of a continuous-time Gaussian moment filter that is typically used with legacy Deep Integration techniques can result in a positive definiteness problem, where the calculated error covariance matrix is not positive definite. As described below with reference to FIG. 8, embodiments disclosed herein address this positive definiteness problem by using a discrete-time formulation in the code-tracking mechanism. Further, as described below, a conditional probability density (PDF) for the code delay variables given the code measurements is calculated. The conditional PDF can be used to calculate arbitrary moments of code delay and other expected values. Further, by addition of M-Code sideband measurements, embodiments described herein reduce estimation errors and result in significantly improved code tracking accuracy in severe jamming environments.

Referring back to FIG. 2, the code measurements 236 can be forwarded to a predictor 252 that determines one or more features (e.g., statistical properties) of a navigation state variable as a function of the code loop measurements 236. For example, the predictor 252 can determine the conditional probability density function (PDF) of the code delay. As will be discussed in detail with reference to FIG. 8, for each correlator, k, the predictor 252 can determine the conditional probability density function, p(\tilde{e}_{τk}|y(i)), that a hypothesized delay, \tilde{e}_{τj}, occurs, given that the code measurement equals y(i), at time index, i.

An estimator 254 may provide estimated values for signal power, noise power, and noise bias at any sampling tune, on the basis of the code loop measurements 236 and the signal, noise, and noise bias on each correlator.

A tracking filter 256 can generate updated code measurements and process them to provide feedback signals for the carrier and code numerically controlled oscillators that are used in removing Doppler error and generating a local code replica. The tracking filter 256 thereby improves the accuracy of the Doppler remover 220, reduces the delay error associated with the prompt correlator, and generally moves the code tracking loop away from loss of lock. Deep integration processing uses a nonlinear tracking filter 256 that is capable of automatically computing optimal weights for the code loop measurements from each correlator of a correlator bank 230 having an arbitrary design.

The ability to optimally employ correlator banks that may be more narrowly or widely spaced, and/or extend over a larger or shorter range of delay, than a conventional (early, prompt, late) correlator bank, is advantageous because such designs are necessary to track modernized GPS ranging codes. For example, the M-Code signal used by modernized OPS systems has multiple autocorrelation peaks. A conventional tracking filter designed for P(Y)-Code waveforms, which have a single autocorrelation peak, may generate incorrect updated code measurements for M-code if it happens to use correlation samples from more than a single peak, or from the wrong peak. Conventional M-Code tracking filters may employ extended range correlator banks to avoid the errors caused by such “false peaks,” but they require predetermined correlator weights, which are determined at design time using ad hoc methods, preventing the conventional filters from adapting in real time to signal and jammer conditions.

By way of contrast, while the Deep Integration nonlinear tracking filter 256 may also be used with a conventional correlator bank, it is particularly advantageous for extended range and adaptive code tracking because it automatically provides a weighting function for an arbitrary number of delay taps in addition to, early, prompt, and late, at an arbitrary delay spacing. For example, the range and spacing of the delay taps may be optimized to properly sample the multi-peaked M-Code correlation function. The nonlinear tracking filter 256 is able to adaptively and more accurately analyze the code correlation function over a larger range of navigation errors, using an arbitrary correlator bank design, for example, an arbitrary number and spacing of correlators, or a spacing of correlators that adapts to changing signal, noise, and jammer power. In this manner, when severe jamming conditions cause an intermittent loss of code lock, the nonlinear tracking filter 256 is able to reacquire lock without an acquisition cycle if the delay error has not drifted beyond the range of the correlator bank 230.

The nonlinear tracking filter 256 employs information, for example measurement moments of any order, about the entire correlation function of a ranging code signal. It is thereby able to accurately account for the nonlinearity of the M-Code autocorrelation function and avoid the errors caused by “false peaks.” For example, the delay spacing of the correlator bank 230 may be less than or equal to one half of the delay between adjacent peaks of the squared M-code autocorrelation function, and the nonlinear tracking filter 256 is able to automatically apply weights to the code loop measurements that cause the observed correlation function to be optimally sampled. Equivalently put, the nonlinear tracking filter 256 is able to optimally utilize information contained in the upper and lower sidebands of a GPS signal that is modulated with M-code. This feature is advantageous because the multi-peaked structure of the M-Code autocorrelation function transfers power from the carrier frequency into the sidebands.

Further, as shown in FIG. 2, the tracking filter 256 can also be coupled with the supplementary sensors 125 and arranged to receive information, data, and measurements from the supplementary sensors 125. Although not shown in FIG. 2, the tracking filter 255 can provide the supplementary sensors 125 with navigation state estimates and other data that can be used to improve the measurements obtained by the supplementary sensors 125.

The tracking filter can use the in-phase, I_{S}, and quadrature, Q_{S}, signals (e.g., averaged in-phase, I_{S}, and quadrature, Q_{S}, signals), along with code loop measurements from the square law detectors, which provide estimates of code phase error, to generate estimates of position, velocity, attitude, estimates of the error those variables, and other navigational data associated with the navigation processor platform. The tracking filter 256 can use this data to form a state transition matrix and other measurement matrices (e.g., measurement matrices required by the tracking filter equations).

Depending on the design of the navigation system, including the number and type of supplementary sensors 125, the tracking filter 256 can have an arbitrary, and potentially large number of error states for estimating various errors in velocity, position, misalignment, acceleration, altitude, etc. For example, the tracking filter 256 can have one or more position error states, velocity error states, gyro misalignment, bias, or scale factor error states, accelerometer misalignment, bias, or scale factor error states, and/or other error rate states. The tracking filter 256 can use the position error state and the velocity error states to correct possible errors in the positions and/or velocity estimates. Similarly, the tracking filter 256 can use the gyro misalignment, bias, or scale factor error states, accelerometer misalignment, bias, or scale factor error states, and/or other error rate states to correct possible errors associated with the gyro and the accelerometer. The gyro misalignment, bias, or scale factor error states, accelerometer misalignment, bias, or scale factor error states, and/or other error rate states can also allow the tracking filter to continuously calibrate the gyro and accelerometer estimates to achieve better navigation performance. Signals provided by one or more supplementary sensors 125 may be processed according to corresponding sensor models and dynamical models of sensor error to obtain one or more additional variables that may be included in the navigation state vector and used to update the navigation state.

The error states also, allow the tracking filter 256 to provide an NCO feedback signal 258 to the front end 124 to improve error correction of measurements received and processed by the front end 124. This improvement in error correction can, in turn, improve the navigation solution provided by the navigation processor 117.

The output 266 (or estimates) from the tracking filter can be forwarded to an output device 170, such as a display, tracking device, or other navigation device for use in providing navigation or guidance.

FIG. 3 is an example of components that can be included in the navigation processor 117 shown in FIG. 1. As noted with reference to FIG. 2, the discrete in-phase, I_{S}, and quadrature, Q_{S}, signal components can optionally be processed by an upper-sideband selection filter 310 and/or a lower sideband selection filter 320.

For example, as shown in FIG. 3, the discrete in-phase, I_{S}, and quadrature Q_{S}, signal components can be components of a GPS M-code signal having a spectrum 305, similar to that shown in FIG. 3. It should, however, be understood that any type of navigation signal can be used with the embodiments described herein. The GPS M-code signal can be any type of M-code signal known in the art. Generally, the GPS M-code signal can have a plurality of modes or peaks.

Depending on whether a sideband filter used and/or the type of sideband filter used, the upper and/or lower sideband filters 310, 320 can pass the upper and/or lower sidebands of the GPS M-code signal. The filtered signal in each band can be forwarded to a separate bank of correlators. The dotted line shown in FIG. 3 surrounds the kth correlator of at least three different correlator banks, one for the full band IF signal, and one each for the upper and lower band IF signals. For example, the correlators can include at least three banks of correlators 230-1, 230-v, 230-k that receive and correlate the filtered signal, in each of three frequency bands. For example, as shown in FIG. 3, one correlator bank 230-1, from among the correlator banks 230, can be configured to receive the full band M-code signal 305-S. Another correlator bank 230-v can receive the upper sideband M-code signal 310-S. Similarly, another correlator bank 230-k can receive the lower sideband M-code signal 320-S. As shown in FIG. 3, other correlators 330 may be utilized along with the correlator banks 230. For example, the other correlators 330 may include correlator banks used to track the ranging code transmitted by other satellites needed resolve the position of the navigation receiver 120, and may also include correlator banks full-band and upper and lower sideband signals associated with those other satellites.

As noted above, once processed through the correlator and integrator, the output of a correlator k, I(i,k) and Q(i,k), can be forwarded to a detector 235, for example a square law detector 235. The square law detector 235 can provide a sum, y(f, k), of the squares of the correlator output functions, I(i,k) and Q(i,k).

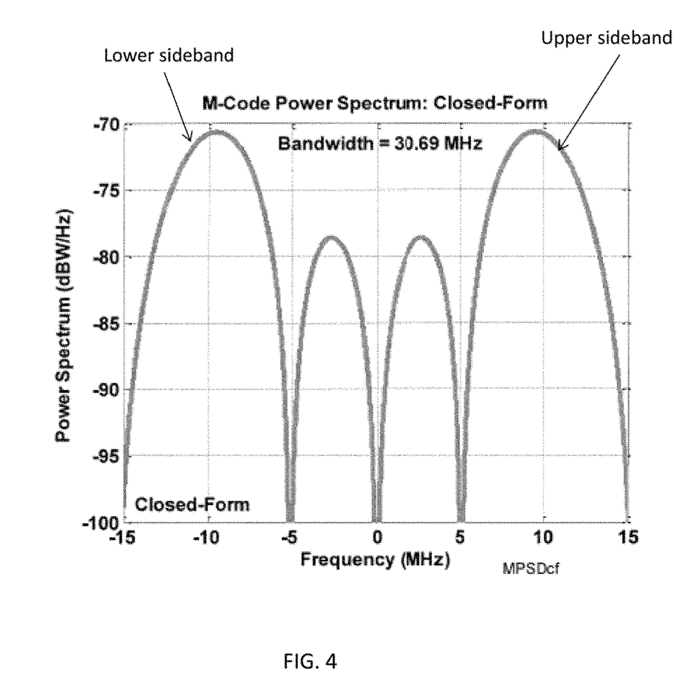

FIG. 4 is an example of a power spectral density of a full-band M-code GPS ranging waveform that can be used with embodiments of the navigation system 100 described herein. As shown, the M-code GPS signal can have a symmetric multimodal spectrum, with multiple modes or peaks, including peaks away from the carrier frequency of the GPS signal. For example, the signal can have an upper sideband (shown in frequency ranges of 5 to 15 MHz offset from the carrier frequency) and a lower sideband (shown in frequency ranges of −15 to −5 MHz offset from the carrier frequency). The upper sideband and lower sidebands can be symmetric, Because the upper and lower sidebands of the M-code GPS signal can contain a significant fraction of the total power in the signal, it is advantageous to incorporate them in the tracking system design. In the example illustrated, the integrated power in the upper and lower sidebands equals 90% of the total power in the M-code GPS signal.

FIG. 5A illustrates the autocorrelation functions of example M-code GPS signals at various IF bandwidths, as a function of code delay measured in units of code chip intervals, where one chip is the period of the spreading code that modulates the GPS signal. For example, the autocorrelation functions for IF bandwidths of 30.69 MHz, 24 MHz, and 20 MHz are shown. FIG. 5B illustrates the squared autocorrelation functions of example M-code signals at various IF bandwidths. For example, the squared autocorrelation functions for IF bandwidths of 30.69 MHz, 24 MHz, and 20 MHz are shown. While narrow IF bandwidths may reduce the noise or jammer power included in the IF signal, thereby reducing code tracking errors and improving tracking loop performance, this beneficial effect must be weighed against the loss of information about the received ranging code signal caused by the IF filter. For example, as shown in FIG. 5B, the unfiltered M-code squared autocorrelation function (BW=inf), which omits the effects of front-end band limiting, has the sharpest and most accurately spaced peaks, from which the most precise and accurate estimates of code delay may be obtained. As the IF bandwidth is reduced, the peaks broaden, reducing the precision of the code delay estimates. At the narrowest IF bandwidth illustrated, (BW=20 MHz), the squared autocorrelation peaks are not only broader, but also have shifted to a wider spacing, both effects resulting from the loss of information from the sidebands of the M-code signal. The change of spacing can produce spurious and inaccurate correlation results.

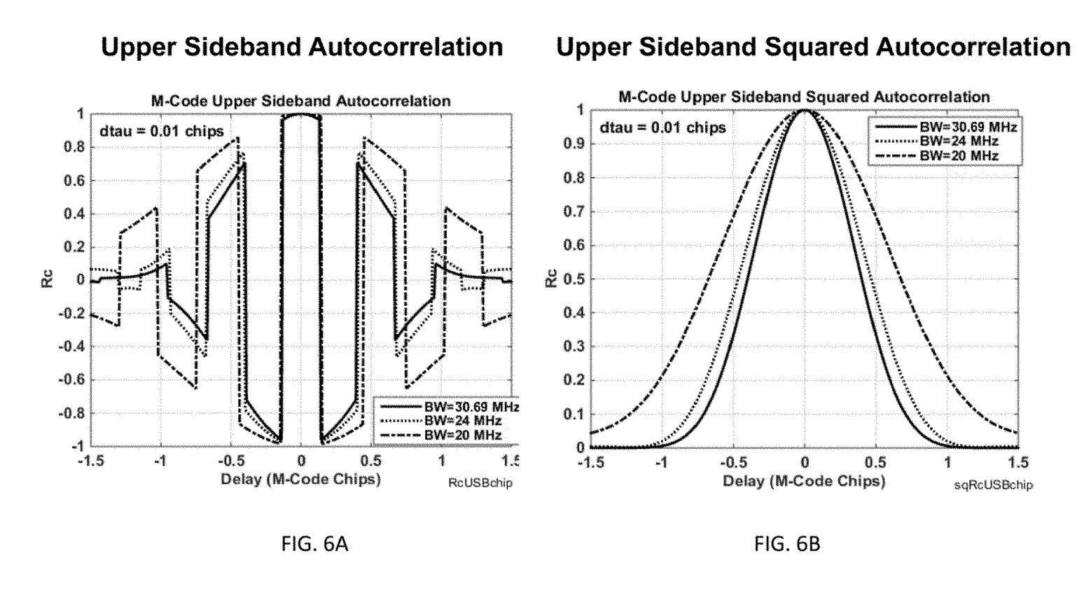

FIG. 6A illustrates the upper sideband autocorrelation function for an M-code modulated GPS signal that can be used with the embodiments described herein. FIG. 6B illustrates the upper sideband squared autocorrelation function for an M-code GPS signal that can be used with the embodiments described herein. In embodiments, the upper sideband IF signals used in the autocorrelation are obtained by applying an upper sideband selection filter to the full band IF signal. The illustrated results correspond to full band IF signals having bandwidths of 30.69 MHZ, 24 MHz, and 20 MHz, filtered using an upper sideband selection filter that is an ideal passband. In FIGS. 6A and 6B, dtau refers to the integration step used in, calculating the autocorrelation function or squared autocorrelation function. As FIG. 6B illustrates, the upper, sideband squared autocorrelation function of an M-code GPS signal has a single peak for each IF bandwidth illustrated. The lower sideband M-Code signal is symmetric, and its squared autocorrelation function (not shown) can be identical to that of the upper sideband, also having a single peak. Advantageously, the characteristic of having a single peak is shared by the squared autocorrelation function of legacy P(Y)-code GPS signals, allowing proven P(Y)-code tracking filters to be used to make code measurements on the basis of M-Code single sideband IF signals. For example, an early, prompt, late correlator bank having a suitable delay spacing may be used to estimate code delay error on the basis of an M-Code sideband signal. In such an example, an early minus late detector using M-code single sideband code measurements is able to drive a tracking loop so as to center the correlator banks about zero code delay error. In embodiments, the navigation processor 117 may generate code measurements using separate correlator banks for each of the upper sideband M-code IF signal, the lower sideband IF signal and the full band IF signal. The nonlinear tracking filter 256 is able to automatically determine and apply optimal weights to code measurements derived from each of the correlator banks. Combining code measurements from two or more IF signal bands may improve the performance of the nonlinear tracking filter 256, relative to its performance using a single band.

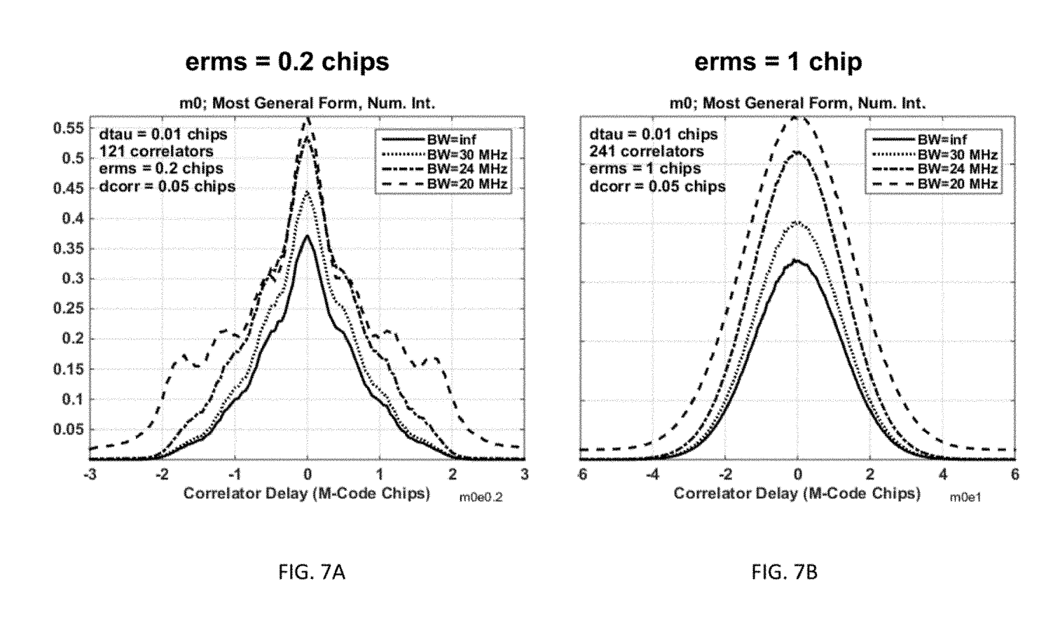

FIG. 7A illustrates a zeroth order measurement moment as a function of correlator delay, assuming an a priori value of 0.2 M-Code chips for the root-mean-squared pseudorange estimation error. The zeroth order measurement moment is the conditional expectation of the nonlinear measurement function, which varies with the correlator delay according to the code autocorrelation function. The zeroth order moment, as well as higher order moments of the measurement function, are used by the nonlinear tracking filter 256. Values of the moment are plotted for filtered IF signals having exemplary bandwidths of 20 MHz, 24 MHz, 30 MHz, and infinity. As IF bandwidth decreases, ibis a fixed value of pseudorange estimation error, the zeroth order moment increases at large values of correlator delay, corresponding to loss of precision in the tracking loop performance. The illustrated behavior of the zeroth order moment as a function of IF bandwidth is representative of the behavior of the higher order moments. FIG. 7B illustrates a zeroth order measurement moment as a function of correlator delay for a mot-mean-squared a priori pseudorange estimation error of 1.0 M-Code chips. Results are shown for IF bandwidths of 20 MHz, 24 MHz, 30 MHz, and infinity.

FIG. 8 is an example of processes that may be performed by the predictor 252 of FIG. 2 in order to determine the conditional probability density function for the code measurement. As shown in FIG. 8, a combiner/correlator 1030 takes the k-th correlator delay, Δₖ, and the j-th hypothesized delay, e_{τj}, as input and uses these factors to determine a correlation function (e.g., an autocorrelation function or a cross correlation function), R_{c}. The correlation function, R_{c}, is input to an adder 1020 that also takes the bandwidth γ of the IF signal and the signal to noise ratio, SNR(i), at time step i as inputs. This allows the correlation function to be scaled by a factor of γ.

The output of the adder 1020 is a prior estimate, h′ⱼ(i, k), of code delay for time step i and correlator k. This estimate h′ⱼ(i,k) is subtracted from the code measurement y(i,k) for time index i and correlator k in an adder 1010 to calculate a residual 1040. This residual 1040 is small if the prior estimate accurately tracks the code measurement (e.g., if the prior measurement estimate h′ⱼ(i,k) agrees with the code measurement at time i and correlator k).

The residuals 1040 and estimates of the, measurement noise covariance matrix provided by the estimator 254, combined 1045 over all correlators are processed 1050 to produce the parameters of a negative log likelihood (NLL) function. The exponent of the NLL function is proportional to the squared value of the ratio of the j-th hypothesized delay, e_{τj}, to the prior RMS pseudorange estimation error,

$${σ}_{τ}^{′} ( i . e . , {[ \frac{{e}_{τ j}}{{σ}_{τ}^{′}} ]}^{2} ) .$$

The resulting NLL function estimates the conditional probability density function (conditional PDF or CPDF) of the code delay, given the code measurements at time step i, p(\tilde{e}_{τk}|y(i)).

In one example, the CPDF may be used to estimate the conditional mode of the code delay, given the values of the code loop measurements for time step i and correlator k, as:

$${\hat{e}}_{τ}^{mode} ( y ) = arg { max}_{{\tilde{e}}_{τ j} ɛ {S}_{τ}} \{ p ( {\tilde{e}}_{τ j} \vert y ) \} ,$$

where S_{τ} is a set of all hypothesized delays. The navigation processor 117 may use the conditional mode or the conditional mean of the delay as an estimate of pseudorange error.

In another example, the CTDF may be used to estimate the conditional mean of the code delay as:

\tilde{e}_{τ}^{mean}(y)=Σ_{\tilde{e}}_{_{τj}}ϵs_{τ}\tilde{e}_{τj} p(\tilde{e}_{τj}|y).

The CPDF may also be used to estimate the conditional variance of the code delay as:

var(\tilde{e}_{τ}(y))=Σ_{\tilde{e}}_{_{τj}}_{ϵS}_{_{τ}}[\tilde{e}_{τj}−\tilde{e}_{τ}^{mean}(y)]²p(\tilde{e}_{τj}|y).

Using embodiments of the discrete time formulation of the nonlinear filtering equations for code tracking, illustrated in FIG. 8, the conditional probability density function of the code delay is estimated directly on the basis of discrete time samples of the code measurements. The conditional PDF incorporates all the information available from the received GPS code. It may be used to calculate arbitrary moments of the code delay, which may, in turn, be used to calculate directly various elements of the navigation state that are derivable from information about the pseudorange. By contrast, in a continuous time formulation, the navigation state elements evolve according to a stochastic differential equation, for example, the Ito stochastic differential equation, which must be solved by numerical integration using a discrete time approximation. Solution of the stochastic differential equation requires that the conditional covariance matrix of the delay error be inverted, which leads to a singularity and prevents a navigation solution, if the covariance matrix is not positive definite. The covariance matrix may be non-positive-definite if, for example, it is calculated using accurate code measurements, but large a priori errors, such as may occur near loss of lock. As a result, ad hoc methods must as continuous time formulations to ensure that the covariance matrix is positive definite, so that a navigation solution can be obtained under all conditions. Embodiments of the discrete time formulation according to the present invention avoid the need to invert the covariance matrix, and thereby eliminate the non-positive-definiteness problem. The calculated error covariance matrix is positive-definite by construction from the variance, var(\tilde{e}_{τ}(y)), since the calculated conditional PDF is non-negative everywhere.

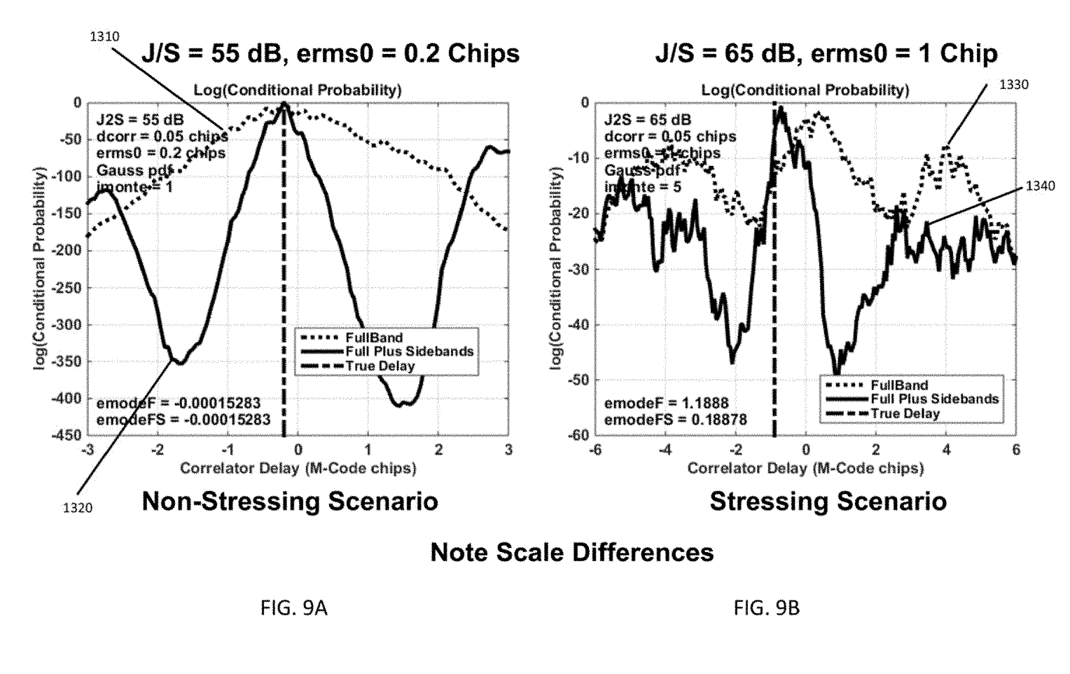

FIGS. 9A and 9B illustrate aspects of the relative improvement in code tracking performance that may be obtained if the navigation processor 117 separately uses the sidebands of the M-Code GPS signal in addition to the full band signal, according to the present invention. The figures compare a simulated jamming scenario that is stressing (jammer to signal ratio, J/S, of 65 dB) to a scenario that is non-stressing (J/S=55 dB). Both figures assume an IF bandwidth of 24 MHz, correlator banks having a correlator, spacing (dcorr) of 0.05 chips, received signal power of ˜158 dBW or 5 dB above P(Y) Code, and measurement wise having a Gaussian a priori probability distribution. Referring to FIG. 9A, a full band conditional PDF 1310 of code delay, obtained using only the full band IF signal, exhibits multiple peaks, corresponding to the multiple peaks of the M-Code squared autocorrelation function, described above with reference arc FIG. 5B. At a J/S ratio of 55 dB, the magnitudes of the peaks decline at delay values away from the true delay of ˜0.2, so that the mode, or global maximum, of the full band conditional PDF 1310 accurately estimates the delay error. A corresponding full band plus sideband conditional PDF 1320 of code delay, obtained using not only the full band IF signal, but also the upper and lower sidebands, exhibits only a single peak, corresponding to the single peak of the M-Code upper sideband squared autocorrelation function, described above with reference to FIG. 6B. The mode of the full band plus sideband conditional PDF 1320 also accurately estimates the delay error, and the two approaches show no performance difference at a J/S ratio of 55 dB. Referring to FIG. 9B, a full band conditional PDF 1330 of code delay at a J/S ratio of 65 dB no longer exhibits a multi-peaked structure because of the increased interference, and the mode of the distribution is shifted away from the true delay of +1.85 chips, resulting in an inaccurate estimate of delay error. By way of contrast, a corresponding full band plus sideband conditional PDF 1340 of code delay retains its single peak in spite of the increased interference and its mode continues to provide an accurate estimate of delay error. Comparing FIGS. 9A and 9B illustrates that a navigation processor 117 achieves improved performance at a stressing J/S level, with no loss of performance at a non-stressing J/S level, by using the sidebands of the M-Code GPS signal addition to the full band signal. At both J/S levels, the full band plus sideband conditional probability density function (CPDF) advantageously falls off more quickly away from its global peak than the full band only CPDF, but the performance improvement that results from using the full band plus sideband signals is greater at the stressing J/S level.

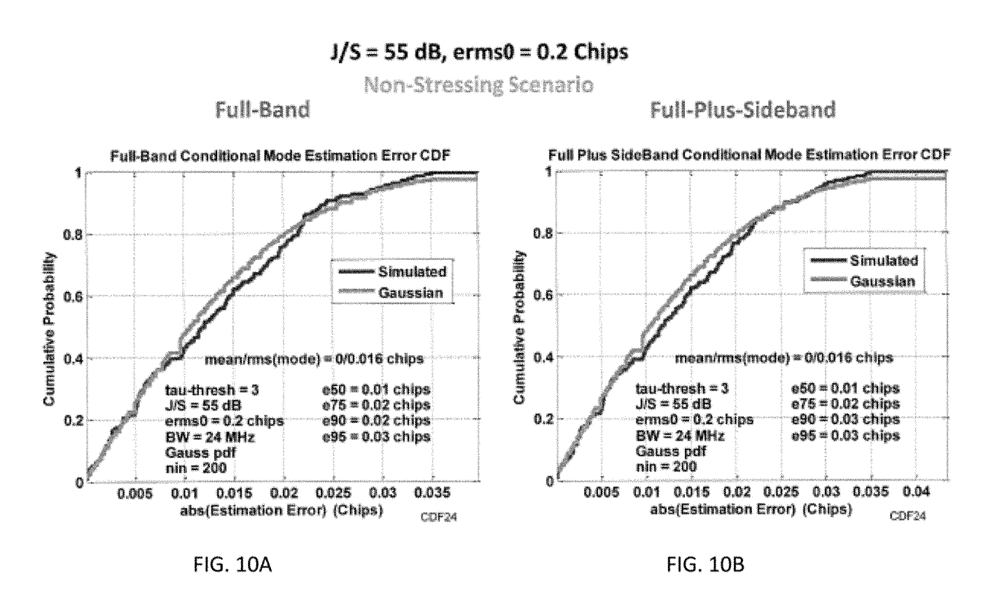

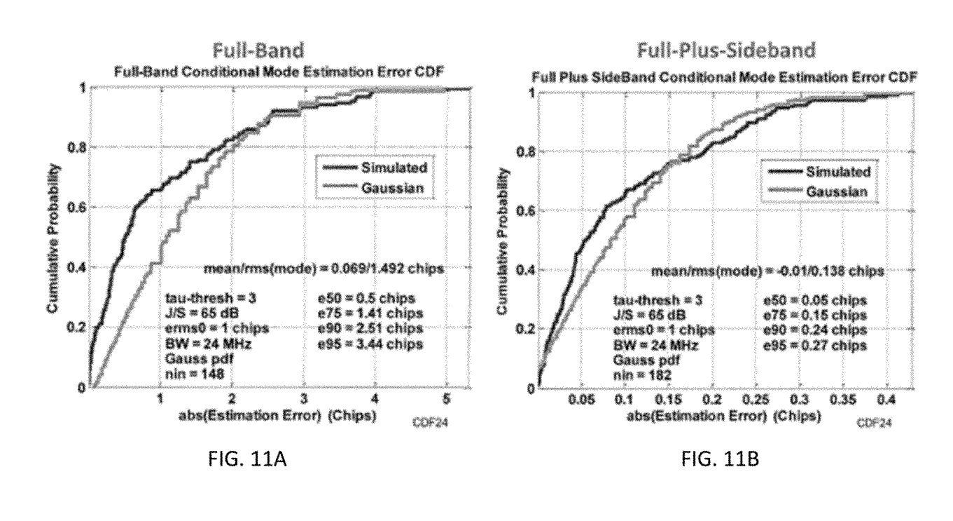

FIGS. 10A, 10B, 11A and 11B illustrate other aspects of the relative improvement in code tracking performance that may be obtained if the navigation processor 117 separately uses the sidebands of the M-Code GPS signal in addition to the full hand signal, according to the present invention. Each figure compares a hypothetical Gaussian distribution to a calculated cumulative probability density function for absolute delay estimation errors calculated a posteriori, using results from a Monte Carlo simulation. The inputs to the Monte Carlo simulation include randomized values of initial conditions, for example, randomized values of a priori pseudorange error. The Monte Carlo simulation had 200 runs; the delay estimate acceptance threshold was 3 chips; and the effects of equalization, aliasing, and Doppler loss were omitted. The delay estimate acceptance threshold was used to perform an outlier test, according to which values of delay estimation error greater than the threshold were discarded from the simulation. The nominal received signal power level was ˜158 dBW. The simulated error corresponds to a single pseudorange measurement from a single satellite.

Referring to FIGS. 10A and 10B, at a non-stressing J/S ratio of 55 dB, the a posteriori conditional cumulative distribution function for estimation errors in delay mode is close to Gaussian whether the navigation processor 117 uses only the full band IF signal or also uses the separate IF sidebands. In the example illustrated, using the full band IF signal plus sidebands provides equivalent performance to using the full band signal alone, as measured by the ability of both methods to produce estimation errors that behave according to a Gaussian probability distribution. It is preferable that the conditional delay mode estimation errors obtained from the Monte Carlo simulation be Gaussian-distributed, because the deeply integrated measurement updating filter assumes an underlying Gaussian a priori conditional probability density function for errors in the measurements of the navigation state variables. The assumption that the a priori PDF is Gaussian has proven to be justified when the a posteriori PDF is unimodal, for example, Gaussian. In contrast, referring to FIGS. 11A and 11B, at a stressing J/S ratio of 65 dB, the conditional cumulative distribution function for estimation errors in delay mode is close to Gaussian if the navigation processor 117 uses the full band IF signal plus the separate IF sidebands, but departs from Gaussian if it uses only the full band IF signal. Comparing FIGS. 10A and 10B to FIGS. 11A and 11B illustrates that a navigation processor 117 achieves improved performance at stressing J/S ratios, with no loss of performance at non-stressing J/S levels, by using the side ands of the M-Code GPS signal in addition to the full hand signal.

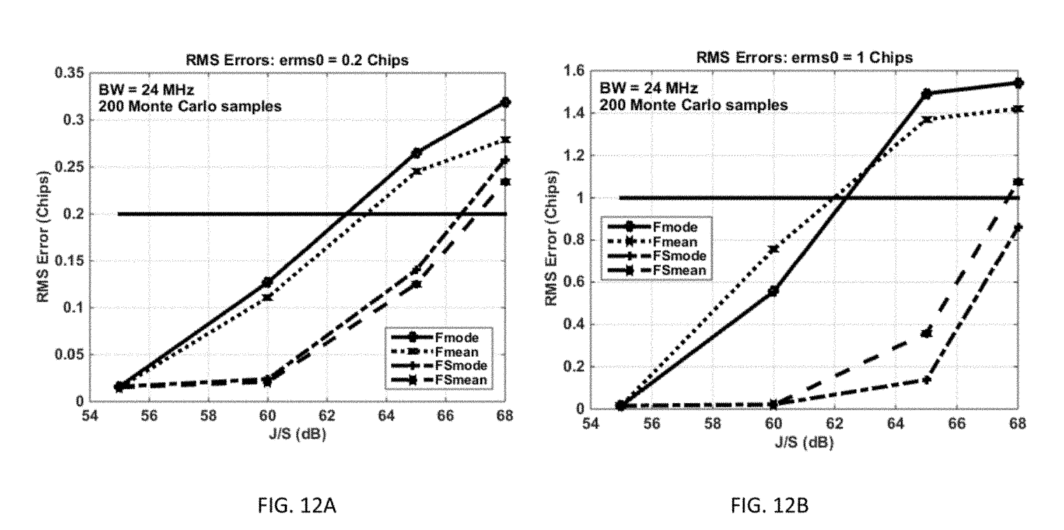

Referring to FIGS. 12A and 12B, either the conditional mode or conditional mean of the delay may be used as an estimate of pseudorange error. FIG. 12A illustrates the root-mean-squared delay tracking error as a function of J/S ratio for a deeply integrated navigation processor 117 that uses the full band M-Code intermediate frequency (IF) signal and, separately, the M-Code IF sideband signals, in comparison to one that uses only the full band IF signal, for an M-code signal having an a priori root-mean-square (RMS) pseudorange error of 0.2 chips. Using the conditional mean results in reduced tracking error at all J/S ratios for this amount of a priori pseudorange error, whether or not the processor 117 uses full band plus sideband measurements. The horizontal line indicates an approximate value of RMS tracking error, 0.2 chips, above which the tracking loop loses lock. Above the horizontal line the a posteriori delay tracking error exceeds the a priori value, indicating a loss of information in processing the nonlinear measurement. The J/S ratio at which a tracking error curve crosses the horizontal line corresponds to a loss-of-lock threshold. At J/S ratios greater than the loss-of-lock threshold, the tracking loop may be expected to lose lock. A deeply integrated navigation processor 117 that uses full band plus sideband measurements extends the loss-of-lock threshold from a J/S ratio of approximately 63 dB to a J/S ratio of 67 dB, relative to a processor 117 that uses only the full band measurements. In this manner, a navigation processor 117 that separately uses the sidebands of the M-Code GPS signal in addition to the full hand signal, according to the present invention, extends the loss-of-lock threshold by approximately 4 dB.

For comparison, FIG. 12B illustrates Monte Carlo simulation results corresponding to those of FIG. 12A, but for an M-code signal having an a priori root-mean-square (RMS) pseudorange error of 1.0 chip. In this example, a navigation processor 117 that separately uses the sidebands of the M-Code GPS signal in addition to the full band signal extends the loss-of-lock threshold by approximately 6 dB. FIG. 12B illustrates that tracking error is minimized by using the conditional mode to estimate pseudorange error and designing the navigation processor 117 to use full band plus sideband measurements in the tracking filter.

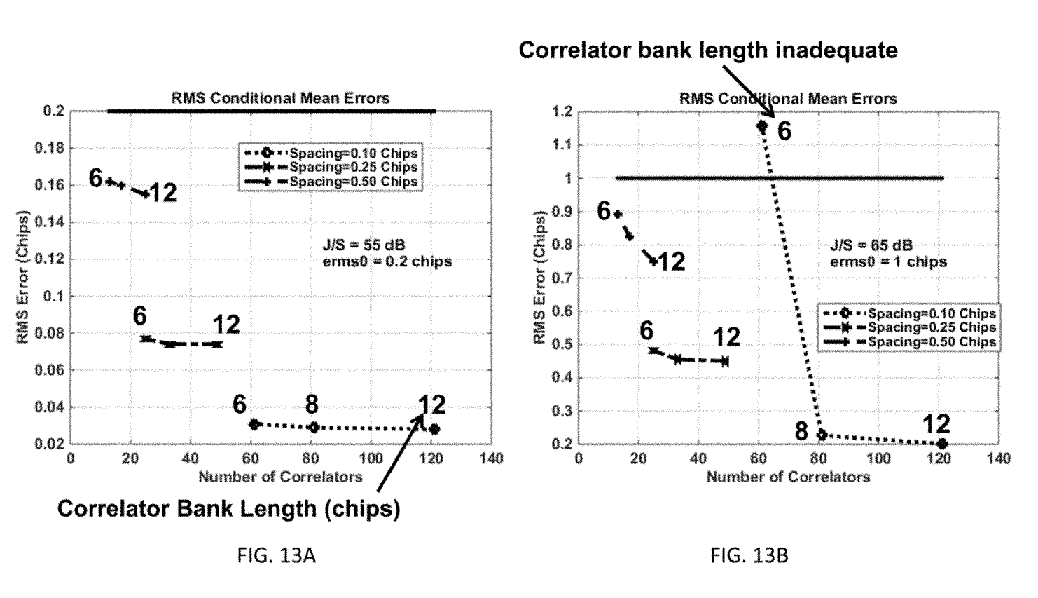

Referring to FIGS. 13A and 13B, a deeply integrated navigation processor that uses the full hand M-Code IF signal and, separately, the M-Code IF sideband signals produces a delay tracking error that is a function of correlator bank length and spacing, for fixed values of J/S ratio and a priori pseudorange error. For, example, FIG. 13A illustrates that tracking errors decrease as correlator spacing decreases, at a J/S ratio of 55 dB, for M-code signal having an a priori root-mean-square (RMS) pseudorange error of 0.2 chip. This behavior may be understood with reference to the M-Code squared autocorrelation function illustrated in FIG. 5B. Tighter correlator spacing, for example, spacing that decreases from 0.5 chips to 0.1 chips, allows the banks 30 of the navigation processor 117 to better resolve the shape of the squared autocorrelation function, including accurately locating the peaks and valleys of the squared autocorrelation as a function of delay. Improving the accuracy of the autocorrelation feature locations directly reduces the tracking errors. FIG. 13A also illustrates that tracking errors decrease only modestly with increasing correlator bank length, provided that the length covers the a priori pseudorange error.

Referring to FIG. 13B, the tracking errors of a deeply integrated navigation processor decline with increasing correlator bank resolution and length, also at a J/S ratio of 65 dB, for an M-code signal having an a priori root-mean-square (RMS) pseudorange error of 1.0 chip. FIG. 13B illustrates an example of aa correlator bank not long enough to adequately sample the M-code squared autocorrelation function at this a priori pseudorange error. Tracking error is greater than a priori pseudorange error—indicating loss of information in the tracking filter—for a correlator bank containing six correlators, spaced at 0.1 chips. The total range extent of the correlator bank is 0.6 chips, less than the a priori pseudorange error of 1.0 chip.

Embodiments of the invention disclosed herein offer a variety of advantages, including improved code tracking performance near loss-of-lock, relative to conventional GNSS receivers. The invention does not require all of the advantageous features, nor must every embodiment provide all of the advantages. Some of the advantages will be explained in the following paragraphs, and others'will be apparent from the foregoing description of embodiments.

Embodiments of the invention overcome the error covariance matrix non-positive definiteness problem that occurs in conventional approaches requiring time-discretization of continuous-time nonlinear filtering equations. Furthermore, in embodiments of a navigation processor that separately uses the sidebands of the M-Code GPS signal in addition to the full band signal, the addition of the sideband measurements reduces estimation error's and results in significantly improved code tracking performance in severe jamming environments.

Because the M-Code squared autocorrelation function is multi-peaked as a function of code delay, M-Code tracking is highly sensitive to correlator spacing. Advantageously, a Deep Integration tracking filter according to the present invention is capable of automatically applying optimal weights to all correlator outputs to construct the optimal detector shape. In contrast to Deep Integration, conventional linear filter techniques rely on fixed linear combinations of the correlator outputs and cannot accommodate arbitrary correlator structures. As a result, the linear techniques must be supplemented by ad hoc approaches to address the nonlinear M-Code correlation function.

Deep Integration extends the region of filter convergence by accounting for nonlinearities in the state vector propagation functions and nonlinearities in the measurement functions. Current methods, which rely on gradients (as in the extended Kalman filter or higher-order Gaussian moment filters) or a limited statistical characterization of the error probability distribution (as in the unscented Kalman filter), do not account for such nonlinearities. Advantageously, the Deep Integration filter accounts for the nonlinearities directly by accurately approximating the true a posteriori conditional PDF.

Not all of the foregoing advantageous features or all of the advantages need be incorporated in every embodiment of the invention.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of art order for various steps should not be understood to require a particular order of execution for those steps, unless required by a particular application, or explicitly stated or otherwise clear from the context.

The methods or processes described above, and steps thereof, may be realized in hardware, software or any combination of these suitable for a particular application. The hardware may include a general-purpose Computer an or dedicated computing device. The processes may be realized in one or more microprocessors, microcontrollers, embedded microcontrollers, programmable digital signal processors, or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as or any other high-level or low-level programming language (including assembly languages, hardware description languages, and database programming languages, and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. navigation system for a mobile platform, comprising:
a navigation receiver configured to receive an analog signal containing global navigation satellite system data, and to generate therefrom a received navigation signal comprising digitized samples;
correlator bank configured to generate a discrete correlation function on the basis of the received navigation signal and a reference navigation signal stored in the navigation system;
a detector configured to generate discrete-time ranging code measurements on the basis of the discrete correlation function;
a predictor configured to estimate a conditional probability density function (conditional PDF) of ranging code delay as a function of the discrete-time ranging code measurements, the conditional PDF being indicative of a probability that a hypothesized delay is realized, given the discrete-time ranging code measurements; and
a discrete-time nonlinear tracking filter configured to generate estimates of navigation state elements of the mobile platform as a function of the conditional PDF.

2. The navigation system of claim 1, further comprising:
one or more supplementary sensors configured to obtain measurements relating to at least one of position attitude, or motion of the mobile platform; and
wherein the nonlinear tracking filter processes the conditional PDF together with the measurements obtained by the supplementary sensors to generate estimates of the navigation state elements of the mobile platform.

3. The navigation system of claim 2, wherein the one or more supplementary sensors comprise at least one inertial sensor, the inertial sensor being at least one of an accelerometer and a gyroscope.

4. The navigation system of claim 2, wherein the measurements obtained by the supplementary sensors comprise at least one of measurements of position, velocity, acceleration, attitude, rotation rate, change in position, change in velocity, and change in attitude of the mobile platform.

5. The navigation system of claim 1, wherein:
the detector is further configured to multiply the discrete correlation function by a discrete weighting function, and from the product thereof to generate the discrete-time ranging code measurements; and
the nonlinear tracking filter is further configured to generate the discrete weighting function as a function of a pseudorange error and a noise and interference to signal ratio.

6. The navigation system of claim 1, further comprising:
at least one of an upper sideband selection filter and a lower sideband selection filter, each sideband selection filter being configured to generate from the received navigation signal a bandpass-limited upper sideband signal or a bandpass-limited lower sideband signal, respectively; and
wherein the correlator bank comprises two or more groups of correlators, each group of correlators being configured to generate a discrete correlation function on the basis of one of two or more reference navigation signals stored in the navigation system and one of the received navigation signal, the upper sideband signal, and the lower sideband signal; and
wherein the detector is configured to generate the discrete-time ranging code measurements on the basis of all the discrete correlation functions, taken together.

7. The navigation system of claim 6, wherein:
the detector is further configured to multiply the discrete correlation function by a discrete weighting function, and from the product thereof to generate the discrete-time ranging code measurements; and
the nonlinear tracking filter is further configured to generate the discrete weighting function as a function of a pseudorange error and a noise and interference to signal ratio.

8. The navigation system of claim 7, further comprising:
one or more supplementary sensors configured to obtain measurements relating to at least one of position, attitude, or motion of the mobile platform; and
wherein the nonlinear tracking filter processes the conditional PDF together with the measurements obtained by the supplementary sensors to generate estimates of the navigation state elements of the mobile platform.

9. A navigation system for a mobile platform, comprising:
a navigation receiver configured to receive an analog signal containing global navigation satellite system data, and to generate therefrom a received navigation signal comprising digitized samples;
at least one of an upper sideband selection filter and a lower sideband selection filter, each sideband selection filter being configured to generate from the received navigation signal a bandpass-limited upper sideband signal or a bandpass-limited lower sideband signal, respectively;
a correlator bank comprising two or more groups of correlators, each group of correlators being configured to generate a discrete correlation function on the basis of one of two or more reference navigation signals stored in the navigation system and one of the received navigation signal, the upper sideband signal, and the lower sideband signal;
a detector configured to generate discrete-time ranging code measurements on the basis of all of the discrete correlation functions, taken together;
a predictor configured to estimate a conditional probability density function (conditional PDF) of ranging code delay as a function of the discrete-time ranging code measurements, the conditional PDF being indicative of a probability that a hypothesized delay is realized, given the discrete-time ranging code measurements; and
a discrete-time nonlinear tracking filter configured to generate estimates of navigation state elements of the mobile platform as a function of the conditional PDF.

10. The navigation system of claim 9, wherein:
the detector is further configured to multiply the discrete correlation functions by a discrete weighting function, and from the product thereof to generate the discrete-time ranging code measurements; and
the nonlinear tracking filter is further configured to generate the discrete weighting function on the basis of a pseudorange error and a noise and interference to signal ratio.

11. The navigation system of claim 9, further comprising:
one or more supplementary sensors configured to obtain measurements relating to at least one of position, attitude, or motion of the mobile platform; and
wherein the nonlinear tracking filter processes the conditional PDF together with the measurements obtained by the supplementary sensors to generate estimates of the navigation state elements of the mobile platform.

12. The navigation system of claim 11, wherein the one or more supplementary sensors comprise at least one inertial sensor, the inertial sensor being at least one of an accelerometer and a gyroscope.

13. The navigation system of claim 11, wherein the measurements obtained by the supplementary sensors comprise at least one of measurements of position, velocity, acceleration, attitude, rotation rate, change in position, change in velocity, and change in attitude of the mobile platform.

14. The navigation system of claim 10, further comprising:
one or more supplementary sensors configured to obtain measurements relating to at least one of position, attitude, or motion of the mobile platform; and
wherein the nonlinear tracking filter processes the conditional PDF together with the measurements obtained by the supplementary sensors to generate estimates of the navigation state elements of the mobile platform.

15. A method for generating estimates of navigation state elements of a mobile platform, comprising:
receiving an analog signal containing global navigation satellite system data, and generating therefrom a received navigation signal comprising digitized samples;
correlating the received navigation signal and a reference navigation signal stored in the navigation system to form a discrete correlation function;
detecting discrete-time ranging code measurements from the discrete correlation function;
estimating a conditional probability density function (conditional PDF) of ranging code delay as a function of the discrete-time ranging code measurements, the conditional PDF being indicative of a probability that a hypothesized delay is realized, given the discrete-time ranging code measurements;
estimating, using a discrete-time nonlinear tracking filter operating on the conditional PDF, the navigation state elements of the mobile platform.

16. The method of claim 15, further comprising:
obtaining supplementary measurements relating at least one of position, attitude, or motion of the mobile platform; and
wherein estimating the navigation state elements of the mobile platform comprises operating with the nonlinear tracking filter on the supplementary measurements and the conditional PDF.

17. The method of claim 16, wherein the supplementary measurements comprise measurements made by an inertial sensor, the inertial sensor being at least one of an accelerometer and a gyroscope.

18. The method of claim 16, wherein the supplementary measurements comprise at least one of measurements of position, velocity, acceleration, attitude, rotation rate, change in position, change in velocity, and change in attitude of the mobile platform.

19. The method of claim 15, further comprising:
multiplying the discrete correlation function by a discrete weighting function, and from the product thereof detecting the discrete-time ranging code measurements; and
generating, using the nonlinear tracking filter, the discrete weighting function on the basis of a pseudorange error and a noise and interference to signal ratio.

20. The method of claim 15, further comprising:
filtering the received navigation signal by at least one of an upper sideband selection filter and a lower sideband selection filter, each sideband selection filter being configured to generate from the received navigation signal a bandpass-limited upper sideband signal or a bandpass-limited lower sideband signal, respectively; and
correlating the received navigation signal and the upper sideband signal or the lower sideband signal, each with a corresponding reference navigation signal stored in the navigation system, to form a discrete correlation function for each signal; and
detecting the discrete-time ranging code measurements on the basis of all of the discrete correlation functions, taken together.

21. The method of claim 20, further comprising:
multiplying the discrete correlation function by a discrete weighting function, and from the product thereof detecting the discrete-time ranging code measurements; and
generating, using the nonlinear tracking filter, the discrete weighting function on the basis of a pseudorange error and a noise and interference to signal ratio.

22. The method of claim 21, further comprising:
obtaining supplementary measurements relating to at least one of position, attitude, or motion of the mobile platform; and
wherein estimating the navigation state elements of the mobile platform comprises operating with the nonlinear tracking filter on the supplementary measurements and the conditional PDF.
